(19) United States
(12) Patent Application Publication
(10) Pub. No.: US 2025/0083355 A1
(43) Pub. Date: Mar. 13, 2025

(54) Process for separating, collecting and storing pieces cut from one or more metal sheets and system implementing said process

(71) Applicant: Starmatik Srl Uninominale, Spresiano (TV) (IT)

(72) Inventor: Stefano Fava, Spresiano (TV) (IT)

(21) Appl. No.: 18/829,027

(22) Filed: Sep. 9, 2024

(30) Foreign Application Priority Data
Sep. 13, 2023 (IT) 102023000018840

(51) Int. Cl. B26D 7/18

(52) U.S. Cl. CPC B26D 7/18

(57) ABSTRACT

A process for separating, collecting and storing pieces cut from one or more metal sheets and resulting from at least one cutting step, during which one or more pieces, variously arranged and configured, have been cut on the metal sheet. The present invention concerns also the system implementing this process.

### FIELD OF THE INVENTION

The present invention concerns equipment for laser cutting of sheet metal. More particularly, the present invention concerns a process for separating, collecting and storing pieces cut from one or more metal sheets and a system implementing such process.

### BACKGROUND OF THE INVENTION

Sheet metal laser cutting machines are known, in which a metal sheet is placed on a cutting plane and one or more variously arranged pieces in different shapes are cut from it.

Once the metal sheet has been cut, it can be stripped into the pieces that make it up and the skeleton (or scrap) through manual or automatic operations, directly on the operating area of the cutting machine used. Alternatively, the cut sheet is collected complete with the skeleton and placed outside the operating area of the machine.

The cut pieces are removed from the skeleton on this surface, collected and stored. This can be done manually or by means of automated devices.

Once the cut pieces have been collected, the skeleton is left, which also must be removed from the work surface and stored.

There are automatic or semi-automatic systems that separate the cut pieces and palletize them; said systems are generally produced by the manufacturer of the cutting machine and integrated with it.

Currently, standardized machining is limited to cutting machines, which can work in a completely autonomous manner, even 24 hours a day, executing preset cutting programs.

On the contrary, the operation of separating the cut pieces cannot generally be standardized and automated, as innumerable variables need to be managed, many of which are unpredictable, first of all the exact position of the pieces to be collected, due to possible and not infrequent misplacements of part of the cut pieces and the skeleton.

Therefore, this operation is carried out immediately after the cutting step and is performed on each metal sheet as soon as it leaves the cutting step. This operation also requires control and possibly manual intervention by one or more operators. All the above limits the hourly productivity of the system and the possibility of fully automating sheet metal processing.

### SUMMARY OF THE INVENTION

The subject of the present invention is a new process for separating, collecting and storing pieces cut from one or more metal sheets and a system implementing said process.

The main object of the present invention is to provide a system that allows pieces cut from a metal sheet to be separated, making this operation completely independent of the cutting machine and of the cutting operations from which the metal sheet originates.

Said system, in fact, does not work on the cutting machine or immediately downstream of the latter, but in any other position to which the metal sheets coming from one or more cutting machines are brought, and where the cut pieces are separated from the corresponding skeletons.

The new process thus allows production to be optimized, as it is also possible to collect the cut pieces in a fully automatic and continuous manner, even 24 hours a day.

### BRIEF DESCRIPTION OF THE DRAWINGS

The drawings constitute a part of this specification and include exemplary embodiments of the invention, which may be embodied in various forms. It is to be understood that in some instances various aspects of the invention may be shown exaggerated to facilitate an understanding of the invention.

FIG. 1 is a flow chart illustrating a method according to the invention.

### DETAILED DESCRIPTION OF EMBODIMENTS OF THE INVENTION

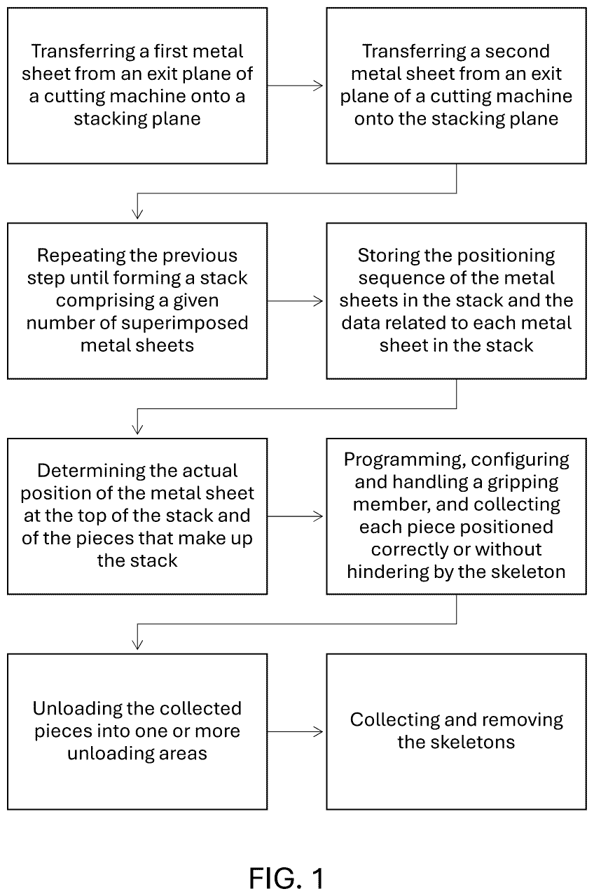

With reference to FIG. 1. a process according to the invention comprises the following steps:
(a) transferring a first metal sheet from an exit plane of a cutting machine onto a stacking plane;
(b) transferring a second metal sheet from an exit plane of a cutting machine onto said stacking plane, where it is superimposed on the previously positioned metal sheet;
(c) repeating the previous step (b) until forming a stack comprising a given number of superimposed metal sheets; the height of the stack can be variable; the number and size of the cut pieces of each metal sheet can be variable. While a metal sheet is being handled, one or more cut pieces may fall onto the stacking plane or onto the underlying metal sheets; therefore, the metal sheets forming the stack may not be positioned in a regular manner and may not be parallel to one another. For example, some cut pieces, which may have different geometric shapes and thicknesses, may be accidentally interposed or even fixed between two metal sheets;
(d) storing the positioning sequence of the metal sheets in the stack and the data related to each metal sheet in the stack, wherein said data includes at least: thickness and dimensions of the metal sheet, geometry, thickness and theoretical arrangement of the cut pieces and of the skeleton, cutting machine which performed the cutting operation;
(e) determining the actual position of the metal sheet at the top of the stack, and of the pieces that make up the stack; this step is intended to determine whether the cut pieces are in positions from which they can be collected or whether they are covered or partially covered by the skeleton of the metal sheet from which they originate. This step is carried out by filming or scanning the surface of the metal sheet and comparing the data obtained from the scan with said stored theoretical data relating to the metal sheet itself, wherein said stored data concerns, as mentioned, the exact arrangement of the pieces, their geometrical shape and their thickness;
(f) for each of the correctly positioned pieces or, in any case, of the pieces that can be collected without the skeleton hindering the operations, programming, configuring and handling at least one gripping member, and successively collecting the piece, wherein said programming/configuring/handling step takes place according to said stored data and to the data processed during said determination step;
(g) unloading the collected pieces into one or more unloading areas related to the same order or to other orders;
(h) collecting and removing the skeleton(s), which is/are positioned in one or more unloading areas; once the pieces meeting the requirements of the previous steps have been collected, in the case where one or more pieces are left which are positioned so that the skeleton of the metal sheet prevents them from being collected. In one embodiment, the skeleton(s) is/are removed and positioned it in one or more unloading areas, and successively the previous steps (f) and (g) are repeated.

The process then starts from the design data related to each metal sheet and to the geometrical shape, thickness and arrangement of the cut pieces and the skeleton.

The skeleton of each metal sheet can in turn be cut into pieces, when it is still in the cutting machine, in order to optimize its storage or facilitate its separation.

The system implementing the process comprises at least one stacking plane on which said stack will be formed, means for handling said stacking plane, if any, at least one gripping member, at least one mechanical system, preferably a CAS (controlled-axis sorting) system, that is, a Cartesian robot with 3 or more axes or one or more anthropomorphic robots with 4 or more coordinated axes each, suited to handle the configuration/movement of said gripping member according to any variant.

Said stacking plane comprises a stacking table or pallet of any size, for example sized and configured to handle metal sheets whose dimensions can even reach 8000×3000 mm, for example.

While the invention has been described in connection with the above-described embodiments, it is not intended to limit the scope of the invention to the particular forms set forth, but on the contrary, it is intended to cover such alternatives, modifications, and equivalents as may be included within the scope of the invention. Further, the scope of the present invention fully encompasses other embodiments that may become obvious to those skilled in the art and the scope of the present invention is limited only by the appended claims.

Therefore, with reference to the above description, the following claims are made.

The invention claimed is:

1. A process for separating, collecting and storing cut pieces from one or more metal sheets produced with at least one cutting step during which one or more uncut pieces, variously arranged and configured, have been cut from the one or more metal sheets, the process comprising:
(a) transferring a first metal sheet from an exit plane of a cutting machine onto a stacking plane where the first metal sheet is transferred while still comprising cut pieces and any remaining portion of the sheet forming a skeleton;
(d) storing the theoretical design data related to the first metal sheet, wherein the theoretical design data comprise at least: thickness and dimensions of a theoretical metal sheet, theoretical geometry, thickness and arrangement of the cut pieces and of the skeleton;
(e) scanning the first metal sheet in its entirety and each of the cut pieces and the skeleton. and comparing the stored theoretical design data and data obtained from the scanning and determining whether one or more of the cut pieces are correctly positioned in precise positions from where the one or more of the cut pieces can be collected or whether the one or more of the cut pieces are entirely or partially covered by other pieces and/or by the skeleton;
(f) for each of the correctly positioned pieces or of the pieces collectable without the skeleton or other pieces hindering collection, programming, configuring and handling at least one gripping member, and collecting the correctly positioned and collectable piece, wherein the programming, configuring, and handling takes place according to the stored theoretical design data and to the obtained data processed during determining;
(g) unloading the collected pieces onto one or more unloading areas; and
(h) after the cut pieces meeting step (f) have been collected, if one or more cut pieces remain which are positioned so that the skeleton of the first metal sheet prevents the one or more cut pieces from being collected, removing the skeleton and positioning the skeleton in the one or more unloading areas, and successively repeating steps (f) and (g).

2. The process according to claim 1, further comprising:
(b) transferring a second metal sheet from the exit plane of the cutting machine onto the stacking plane, where the second metal is superimposed on the first, previously positioned, metal sheet;
(c) if necessary, repeating step (b) until forming a stack comprising a given number of superimposed metal sheets, each comprising one or more of the respective cut pieces and the respective skeleton; and
(d) storing a positioning sequence of the superimposed metal sheets in the stack and theoretical design data related to each metal sheet;
wherein steps (e), (f), (g), (h) are repeated in sequence for each of the superimposed metal sheets, starting from a top of the stack.

3. The process according to claim 1, wherein the skeleton is cut into two or more pieces before step (a) or (b) to facilitate a removal of the skeleton and/or of the cut pieces.

4. The process according to claim 1, wherein the scanning is a 2D/3D scanning, or scanning with a sensor/camera system.

5. A system configured to implement a process according to claim 1 for separating, collecting and storing one or more pieces cut from one or more metal sheets using a cutting step during which the one or more pieces, variously arranged and configured, have been cut from the one or more metal sheets, the system comprising:
a stacking plane, on which a stack formed by the one or more of the metal sheets is to be created;
a gripping member for gripping and handling at least one piece at a time from the one or more pieces from a metal sheet; and
a mechanical system configured to manage a configuration and handling of the gripping member according to preset commands.

6. The system according to claim 5, wherein the mechanical system comprises a CAS (controlled-axis sorting) system comprising a Cartesian robot with three or more axes or one or more anthropomorphic robots with four or more coordinate axes each.

7. The system according to claim 5, wherein the stacking plane is an area on a floor, a flatbed, or a pallet having a fixed or movable support.

8. The system according to claim 5, further comprising one or more unloading areas where cut and collected pieces can be unloaded which may be of a same order or of a plurality of orders.
